(19) United States
(12) Patent Application Publication
(10) Pub. No.: US 2016/0369174 A1
(43) Pub. Date: Dec. 22, 2016

(54) METHOD AND APPARATUS FOR CRACKING HYDROCARBON

(71) Applicant: GENERAL ELECTRIC COMPANY, Schenectady, NY (US)

(72) Inventors: Lawrence Bernard KOOL, Niskayuna, NY (US); Shizhong WANG, Shanghai (CN); Hong ZHOU, Shanghai (CN); Wenqing PENG, Shanghai (CN); Yanfei GU, Shanghai (CN)

(73) Assignee: General Electric Company, Schenectady, NY (US)

(21) Appl. No.: 15/111,340

(22) PCT Filed: Nov. 19, 2014
(86) PCT No.: PCT/US2014/066254

§ 371 Date: Jul. 13, 2016

(30) Foreign Application Priority Data
Jan. 13, 2014 (CN) 201410014102.9

(51) Int. Cl. C10G 9/20; B01J 19/02; B01J 19/00

(52) U.S. Cl. CPC C10G 9/203; B01J 19/0026; B01J 19/02; C10G 2300/405; B01J 2219/024

(57) ABSTRACT

A method for cracking hydrocarbon includes: providing hydrocarbon; and feeding the hydrocarbon into an apparatus having an inner surface accessible to hydrocarbon, the inner surface comprising a perovskite material and a tuning material; wherein a yield of coke in the apparatus is lower than that in an apparatus without the perovskite material; and a yield of carbon monoxide in the apparatus is lower than that in an apparatus without the tuning material. An associated apparatus is also described.

### BACKGROUND

The invention relates generally to methods and apparatuses for cracking hydrocarbon. More specifically, the invention relates to methods and apparatuses for cracking hydrocarbon, in which the build-up of coke is undesirable.

During hydrocarbon cracking processes, the build-up of carbonaceous material deposits (e.g. coke) usually happens on inner surfaces of apparatus components, for instance, inner radiant tube surfaces of furnace equipment. The inner radiant tube surfaces become gradually coated with a layer of coke, which raises the radiant tube metal temperature (TMT) and increases the pressure drop through radiant coils. In addition, the coke build-up adversely affects the physical characteristics of the apparatus components, such as the radiant tubes, by deteriorating mechanical properties such as stress rupture, thermal fatigue, and ductility due to carburization.

In order to decoke apparatus components, the hydrocarbon cracking must be periodically stopped. Typically, the decoking is carried out by the combustion of the coke with steam/air. Such decoking operations are required approximately every 10 to 80 days, depending on the operation mode, types of hydrocarbons and hydrocarbons throughput, and result in production loss since hydrocarbons feeding must be stopped for such decoking operation.

A variety of methods have been considered in order to overcome the disadvantages of coke build-up on apparatus components, such as furnace tube inner surfaces. These methods include: metallurgy upgrade to alloys with increased chromium content of the metal substrates used in the furnaces; adding additives such as sulfur, dimethyl sulfide (DMS), dimethyl disulfide (DMDS) or hydrogen sulfide to the feedstock; and increasing steam dilution of feedstock.

While some of the aforementioned methods have general use in some industries, it is desirable to provide a new method and apparatus for cracking hydrocarbon.

### BRIEF DESCRIPTION

In one aspect, embodiments of the invention relate to a method for cracking hydrocarbon, comprising: providing hydrocarbon; and feeding the hydrocarbon into an apparatus having an inner surface accessible to hydrocarbon, the inner surface including a perovskite material and a tuning material; wherein a yield of coke in the apparatus is lower than that in an apparatus without the perovskite material; and a yield of carbon monoxide in the apparatus is lower than that in an apparatus without the tuning material.

In another aspect, embodiments of the invention relate to an apparatus for cracking hydrocarbon having an inner surface accessible to the hydrocarbon, the inner surface comprising a perovskite material and a tuning material; wherein a yield of coke in the apparatus is lower than that in an apparatus without the perovskite material; and a yield of carbon monoxide in the apparatus is lower than that in an apparatus without the tuning material.

### DRAWINGS

These and other features, aspects, and advantages of the present invention will become better understood when the following detailed description is read with reference to the accompanying drawings, wherein:

FIG. 1 illustrates a schematic cross sectional view of a tube of an apparatus according to some embodiments of the invention; and

FIG. 2 shows the timeline and main parameters of the experimental procedure of example 5.

### DETAILED DESCRIPTION

Unless defined otherwise, technical and scientific terms used herein have the same meaning as is commonly understood by one of ordinary skill in the art to which this disclosure belongs. The use of “including”, “comprising” or “having” and variations thereof herein are meant to encompass the items listed thereafter and equivalents thereof as well as additional items.

Approximating language, as used herein throughout the specification and claims, may be applied to modify any quantitative representation that could permissibly vary without resulting in a change in the basic function to which it is related. Accordingly, a value modified by a term or terms, such as “about” is not to be limited to the precise value specified. In some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

In the specification and the claims, the singular forms “a”, “an” and “the” include plural referents unless the context clearly dictates otherwise. Moreover, the suffix “(s)” as used herein is usually intended to include both the singular and the plural of the term that it modifies, thereby including one or more of that term.

As used herein, the term “or” is not meant to be exclusive and refers to at least one of the referenced components (for example, a material) being present and includes instances in which a combination of the referenced components may be present, unless the context clearly dictates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable. For example, in some circumstances, an event or capacity can be expected, while in other circumstances, the event or capacity cannot occur. This distinction is captured by the terms “may” and “may be”.

Reference throughout the specification to “some embodiments”, and so forth, means that a particular element (e.g., feature, structure, and/or characteristic) described in connection with the invention is included in at least one embodiment described herein, and may or may not be present in other embodiments. In addition, it is to be understood that the described inventive features may be combined in any suitable manner in the various embodiments.

Embodiments of the present invention relate to methods and apparatuses for cracking hydrocarbon with reduced yields of coke and carbon monoxide.

As used herein, the term “apparatus” refers to any device that may be used for hydrocarbon cracking. In some embodiments, the apparatus includes at least one of a furnace tube, a tube fitting, a reaction vessel, and a radiant tube. The apparatus may be a pyrolysis furnace comprising a firebox through which runs an array of tubing. The array of tubing and corresponding fittings may be several hundred meters in length. The array of tubing may comprise straight or serpentine tubes.

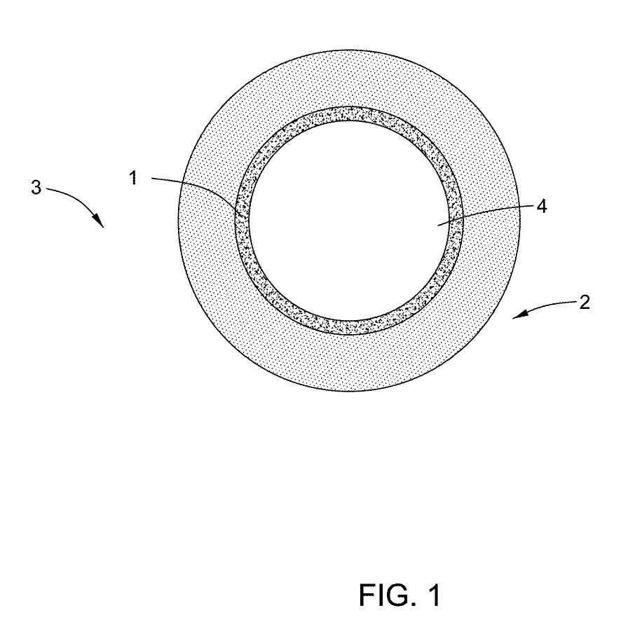

In some embodiments, the inner surface of the apparatus accessible to hydrocarbon comprises a coating of the perovskite material and the tuning material. In some embodiments, as is shown in FIG. 1, the inner surface 1 is in a tube 2 of an apparatus 3, and the hydrocarbon (not shown) passes through the inner space 4.

As used herein the term “hydrocarbon cracking”, “cracking hydrocarbon”, or any variation thereof, refers to but is not limited to processes in which hydrocarbons are cracked in apparatuses to obtain materials with smaller molecules. The hydrocarbon may include ethane, heptane, liquid petroleum gas, naphtha, gas oil, bottoms from atmospheric and vacuum distillation of crude oil, or any combination thereof.

As used herein the term “coke” or any variation thereof refers to but is not limited to carbonaceous solid or liquid, or particulates or macromolecules forming the carbonaceous solid or liquid, which are derived from coal, petroleum, wood, hydrocarbons and other materials containing carbon.

As used herein the term “perovskite material” or any variation thereof refers to but is not limited to any material having an ABO₃ perovskite structure and being of formula AₐB_{b}O_{3-δ}, wherein 0.9<a≦1.2; 0.9<b≦1.2; −0.5<δ<0.5; A comprises a first element and optionally a second element, the first element is selected from calcium (Ca), strontium (Sr), barium (Ba), lithium (Li), sodium (Na), potassium (K), rubidium (Rb) and any combination thereof, the second element is selected from yttrium (Y), bismuth (Bi), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu) and any combination thereof; and B is selected from silver (Ag), gold (Au), cadmium (Cd), cerium (Ce), cobalt (Co), chromium (Cr), copper (Cu), dysprosium (Dy), erbium (Er), europium (Eu), ferrum (Fe), gallium (Ga), gadolinium (Gd), hafnium (Hf), holmium (Ho), indium (In), iridium (Ir), lanthanum (La), lutetium (Lu), manganese (Mn), molybdenum (Mo), niobium (Nb), neodymium (Nd), nickel (Ni), osmium (Os), palladium (Pd), promethium (Pm), praseodymium (Pr), platinum (Pt), rhenium (Re), rhodium (Rh), ruthenium (Ru), antimony (Sb), scandium (Sc), samarium (Sm), tin (Sn), tantalum (Ta), terbium (Tb), technetium (Tc), titanium (Ti), thulium (Tm), vanadium (V), tungsten (W), yttrium (Y), ytterbium (Yb), zinc (Zn), zirconium (Zr), and any combination thereof.

In some embodiments, the perovskite material may be of formula n(AₐB_{b}O_{3-δ}), in which n=2, 3, 4, 8, and etc., and the formula AₐB_{b}O_{3-δ} is the simplified form thereof. In some embodiments, in the ABO₃ perovskite structure, A cations are surrounded by twelve anions in cubo-octahedral coordination, B cations are surrounded by six anions in octahedral coordination and oxygen anions are coordinated by two B cations and four A cations. In some embodiments, the ABO₃ perovskite structure is built from corner-sharing BO₆ octahedra. In some embodiments, the ABO₃ perovskite structure includes distorted derivatives. The distortions may be due to rotation or tilting of regular, rigid octahedra or due to the presence of distorted BO₆ octahedra. In some embodiments, the ABO₃ perovskite structure is cubic. In some embodiments, the ABO₃ perovskite structure is hexagonal.

In some embodiments, A only comprises the first element. The first element may be a single element or a combination of elements selected from calcium (Ca), strontium (Sr), barium (Ba), lithium (Li), sodium (Na), potassium (K), and rubidium (Rb).

In some embodiments, A comprises a combination of the first element and the second element. The second element may be a single element or a combination of elements selected from yttrium (Y), bismuth (Bi), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

Likewise, B may be a single element or a combination of elements selected from silver (Ag), gold (Au), cadmium (Cd), cerium (Ce), cobalt (Co), chromium (Cr), copper (Cu), dysprosium (Dy), erbium (Er), europium (Eu), ferrum (Fe), gallium (Ga), gadolinium (Gd), hafnium (Hf), holmium (Ho), indium (In), iridium (Ir), lanthanum (La), lutetium (Lu), manganese (Mn), molybdenum (Mo), niobium (Nb), neodymium (Nd), nickel (Ni), osmium (Os), palladium (Pd), promethium (Pm), praseodymium (Pr), platinum (Pt), rhenium (Re), rhodium (Rh), ruthenium (Ru), antimony (Sb), scandium (Sc), samarium (Sm), tin (Sn), tantalum (Ta), terbium (Tb), technetium (Tc), titanium (Ti), thulium (Tm), vanadium (V), tungsten (W), yttrium (Y), ytterbium (Yb), zinc (Zn), and zirconium (Zr).

In some embodiments, the perovskite material comprises SrCeO₃, SrZr_{0.3}Ce_{0.7}O₃, BaMnO₃, BaCeO₃, BaZr_{0.3}Ce_{0.7}O₃, BaZr_{0.3}Ce_{0.5}Y_{0.2}O₃, BaZr_{0.1}Ce_{0.7}Y_{0.2}O₃, BaZrO₃, BaZr_{0.7}Ce_{0.3}O₃, BaCe_{0.5}Zr_{0.5}O₃, BaCe_{0.9}Y_{0.1}O₃, BaCe_{0.85}Y_{0.15}O₃, or BaCe_{0.8}Y_{0.2}O₃. For example, for SrCeO₃, A is Sr, a=1, B is Ce, b=1, and δ=0. For SrZr_{0.3}Ce_{0.7}O₃, A is Sr, a=1, B is a combination of Zr and Ce, b=1, and 6=0. For BaMnO₃, A is Ba, a=1, B is Mn, b=1, and 6=0. For BaCeO₃, A is Ba, a=1, B is Ce, b=1, and 6=0. For BaZr_{0.3}Ce_{0.7}O₃, A is Ba, a=1, B is a combination of Zr and Ce, b=1, and δ=0. For BaZr_{0.3}Ce_{0.5}Y_{0.2}O₃, A is Ba, a=1, B is a combination of Zr, Ce and Y, b=1, and δ=0.

In some embodiments, the perovskite material comprises La_{0.1}Ba_{0.9}Ce_{0.7}Zr_{0.2}Y_{0.1}O₃, Ce_{0.1}Ba_{0.9}Ce_{0.7}Zr_{0.2}Y_{0.1}O_{3.05}, Ce_{0.5}Ba_{0.5}Ce_{0.7}Zr_{0.2}Y_{0.1}O_{3.45}, Y_{0.1}Ba_{0.9}Ce_{0.7}Zr_{0.2}Y_{0.1}O₃, Y_{0.5}Ba_{0.5}Ce_{0.7}Zr_{0.2}Y_{0.1}O_{3.2}, Bi_{0.1}Ba_{0.9}Ce_{0.7}Zr_{0.2}Y_{0.1}O₃, Bi_{0.5}Ba_{0.5}Ce_{0.7}Zr_{0.2} Y_{0.1}O_{3.2}, Pr_{0.1}Ba_{0.9}Ce_{0.7}Zr_{0.2}Y_{0.1}O₃, or Pr_{0.5}Ba_{0.5}Ce_{0.7}Zr_{0.2}Y_{0.1}O_{3.2}. For La_{0.1}Ba_{0.9}Ce_{0.7}Zr_{0.2}Y_{0.1}O₃, A is a combination of Ba and La, the first element is La, the second element is Ba, a=1, B is a combination of Ce, Zr and Y, b=1, and, δ=0. For Ce_{0.1}Ba_{0.9}Ce_{0.7}Zr_{0.2}Y_{0.1}O_{3.05} and Ce_{0.5}Ba_{0.5}Ce_{0.7}Zr_{0.2}Y_{0.1}O_{3.45}, A is a combination of Ce and Ba, the first element is Ce, the second element is Ba, a=1, B is a combination of Ce, Zr and Y, b=1, and, δ=−0.05 and −0.45, respectively. For Y_{0.1}Ba_{0.9}Ce_{0.7}Zr_{0.2}Y_{0.1}O₃ and Y_{0.5}Ba_{0.5}Ce_{0.7}Zr_{0.2}Y_{0.1}O_{3.2}, A is a combination of Y and Ba, the first element is Y, the second element is Ba, a=1, B is a combination of Ce, Zr and Y, b=1, and, δ=0 and −0.2, respectively. For Bi_{0.1}Ba_{0.9}Ce_{0.7}Zr_{0.2}Y_{0.1}O₃ and Bi_{0.5}Ba_{0.5}Ce_{0.7}Zr_{0.2}Y_{0.1}O_{3.2}, A is a combination of Bi and Ba, the first element is Bi, the second element is Ba, a=1, B is a combination of Ce, Zr and Y, b=1, and, δ=0 and −0.2, respectively. Similarly, for Pr_{0.1}Ba_{0.9}Ce_{0.7}Zr_{0.2}Y_{0.1}O₃ and Pr_{0.5}Ba_{0.5}Ce_{0.7}Zr_{0.2}Y_{0.1}O_{3.2}, A is a combination of Pr and Ba, the first element is Pr, the second element is Ba, a=1, B is a combination of Ce, Zr and Y, b=1, and, δ=0 and −0.2, respectively.

In some embodiments, the perovskite material comprises BaZr_{0.3}Ce_{0.7}O₃.

As used herein the term “tuning material” or any variation thereof refers to any material that reduces the yield of carbon monoxide in hydrocarbon cracking. The tuning material may comprise one material or a combination of multiple materials. In some embodiments, the tuning material comprises zirconium oxide, doped zirconium oxide, or any precursor or combination thereof.

In some embodiments, the method for cracking hydrocarbon is operated at a temperature in a range from about 700° C. to about 900° C. with the presence of steam, a weight ratio of steam to hydrocarbon is in a range from about 3:7 to about 7:3, and the hydrocarbon includes ethane, heptane, liquid petroleum gas, naphtha, gas oil, or any combination thereof.

In some embodiments, the method for cracking hydrocarbon is operated at a temperature in a range from about 480° C. to about 600° C. in the presence of steam, the hydrocarbon comprises bottoms from atmospheric and vacuum distillation of crude oil and a weight percentage of steam is in a range from about 1 wt % to about 2 wt %.

The perovskite material may or may not chemically react with the tuning material. Thus, the inner surface may comprise a combination or a reaction product of the perovskite material and the tuning material. In some embodiments, the inner surface comprises a combination of the perovskite material, the tuning material and a reaction product of the perovskite material and the tuning material.

The perovskite material and the tuning material may be in a coating applied to the apparatus using different methods, for example, air plasma spray, slurry coating, sol-gel coating, and solution coating. In some embodiments, the perovskite material and the tuning material are coated using slurry coating method.

The amount of the tuning material and the perovskite material in the slurry may vary as long as a continuous, strong, carbon monoxide reducing and anticoking coating is formed, depending on the specific tuning material and the perovskite material being used and the working condition of the coating. In some embodiments, a weight ratio of the perovskite material to the tuning material is from about 7:3 to about 7:93. In some embodiments, a weight of the perovskite material is equal to or less than that of the tuning material.

The slurry may further comprise an organic binder, an inorganic binder, a wetting agent, a solvent or any combination thereof to enhance the slurry wetting ability, tune the slurry viscosity or get good green coating strength. When the organic binder, the inorganic binder, the wetting agent, the solvent or any combination thereof is added in the slurry, a total weight percentage of the tuning material and the perovskite material in the slurry may be from about 10% to about 90%, or preferably from about 15% to about 70%, or more preferably from about 30% to about 55%.

In some embodiments, the slurry comprises the perovskite material, the tuning material, cerium oxide, yttrium oxide, glycerol, and polyvinyl alcohol (PVA).

The slurry may be applied to the apparatus by different techniques, such as at least one of sponging, painting, centrifuging, spraying, filling and draining, and dipping. In some embodiments, the slurry is applied by dipping, i.e., dipping the part to be coated in the slurry. In some embodiments, the slurry is applied by filling and draining, i.e., filling the slurry in the article to be coated and draining out the slurry afterwards by, e.g., gravity.

After the slurry is applied to the apparatus, a sintering process may be followed. As used herein the term “sintering” or any variation thereof refers to but is not limited to a method of heating the material in a sintering furnace or other heater facility. In some embodiments, the sintering temperature is in a range from about 850° C. to about 1700° C. In some embodiments, the sintering is at about 1000° C.

### EXAMPLES

The following examples are included to provide additional guidance to those of ordinary skill in the art in practicing the claimed invention. These examples do not limit the invention as defined in the appended claims.

### Example 1

### BaZr_{0.3}Ce_{0.7}O₃ Powder Preparation

The BaZr_{0.3}Ce_{0.7}O₃ powder was prepared by solid-state reaction method. Stoichiometric amounts of high-purity barium carbonate, zirconium oxide, and cerium oxide powders (all from sinopharm chemical reagent Co., Ltd. (SCRC), Shanghai, China) were mixed in ethanol and ball-milled for about 16 hours. The resultant mixtures were then dried and calcined at about 1450° C. in air for about 6 hours to form the BaZr_{0.3}Ce_{0.7}O₃ powder. The calcined powder was mixed with alcohol and was ball milled for about 16 hours. After the alcohol was dried, fine BaZr_{0.3}Ce_{0.7}O₃ powder (d₅₀=1.5 micron) was prepared.

### Example 2

### Slurry Preparation

CeO₂ sol (20 wt % in H₂O, Alfa Aesar #12730) was obtained from Alfa Aesar Company, Ward Hill, Mass., USA. Polyvinyl alcohol (PVA, M.W.=88,000-97,000) 10% aqueous solution was prepared. ZrO₂ nano powder (99.9% purity %, D₅₀=0.2 μm) was obtained from Xuan Cheng Jing Rui New Material Co., Ltd., Xuan Cheng city, Anhui province, China. Y₂O₃ powder and glycerol were obtained from SCRC.

BaZr_{0.3}Ce_{0.7}O₃ powder prepared in example 1 and different amounts of other components of respective slurries (detailed compositions thereof are shown in table 1 below) were respectively added into plastic jars mounted on speed mixer machines. After mixing for about 3 minutes with the rotation speed of about 3000 revolutions per minute (RPM), respective slurries were prepared.

TABLE 1

| | slurry 1 | slurry 2 | slurry 3 |
|---|---|---|---|
| BaZr_{0.3}Ce_{0.7}O₃ powder (g) | 7.87 | 0.79 | 3.94 |
| CeO₂ sol (g) | 11.92 | 11.92 | 11.92 |
| Y₂O₃ (g) | 0.18 | 0.18 | 0.18 |
| ZrO₂ nano powder (g) | 0 | 7.08 | 3.94 |
| glycerol (g) | 1.09 | 1.09 | 1.09 |
| PVA solution (g) | 3.22 | 3.22 | 3.22 |

### Example 3

### Applying the Slurries to Coupons

A plurality of coupons made from Incoloy 800HT (the composition thereof is listed in table 2 below) each with the dimension of 10×30×1 mm³ were used as the substrates. Before coating, the substrates were cleaned by HCl (10 wt % aqueous solution) and acetone under the ultrasound and deionized water.

TABLE 2
Composition of Incoloy ® 800HT

| Element | Amount (wt %) |
|---|---|
| Ni | 30-35 |
| Cr | 19-23 |
| Fe | >39.5 |
| C | 0.08-0.10 |
| Mn | ≦1.5 |
| Si | ≦1.0 |
| P | 0.015 |
| S | ≦0.015 |
| Cu | ≦0.75 |
| Ti | 0.15-0.60 |
| Al | 0.15-0.60 |
| Al + Ti | 0.85-1.20 |

Cleaned coupons were immersed in the slurries prepared in EXAMPLE 2 and a thin film was formed by dip coating on each coupon. The coated coupons were dried in air for about 2 hours at about 80° C. and were then put into a tube furnace for sintering at about 1000° C. for about 3 hours in vacuum.

### Example 4

### XRD Analysis

X-ray diffraction (XRD) analyses were conducted to examine the coatings on the coupons. BaZr_{0.3}Ce_{0.7}O₃ and Y₂O₃ were found on all the coupons coated with slurry 1, slurry 2 and slurry 3. Barium zirconate, zirconium oxide and zirconium cerium oxide were also found on the coupon coated with slurry 2. The same crystal phases were found on the coupon coated with slurry 3 as those on the coupon coated with slurry 2, and XRD also indicated the existence of cerium yttrium oxide on the coupon coated with slurry 3.

### Example 5

### Jet Stirred Reactor (JSR) Test

Coated coupons and an uncoated coupon were inserted into the JSR. Ethane was cracked at about 886° C. in the JSR with the continuous addition of about 50 ppm of sulfur per hydrocarbon (using DMDS as the source of sulfur) while the amount of coke that deposited on the coupons was continuously monitored via an electrobalance.

The experiments consisted of three main steps: preoxidation, cracking and decoking. To mimic the surface state of an industrial cracking coil, the samples were first oxidized in-situ prior to the cracking runs. For that purpose, the reactor temperature was first raised to about 750° C. with a heating ramp of about 27° C./hour and a constant Na flow (about 6.7·10⁻³ Nl/s). Once this temperature was reached, the feed to the reactor was switched to a constant flow of air only (about 6.7·10⁻³ Nl/s). This preoxidation lasted 12-14 hours, after which, keeping the temperature constant at about 750° C., Na was fed again to the reactor (about 6.7·10⁻³ Nl/s).

To start a cracking run, the temperature of the reactor was raised to about 900° C., with the same Na flow as before (about 6.7·10⁻³ Nl/s). After the weight of the sample was recorded (this was the zero value for the weight measurement), the reactor was further heated to about 1010° C. Water with DMDS (about 11.11·10⁻⁶ kg/s) and ethane (about 0.0275 Nl/s) started being fed to the evaporators (dilution δ=0.33 kg H₂O/kg C₂H₆) and sent to the vent, in order to get a steady evaporation and mixing before sending the stream to the reactor.

Once the reactor temperature was stable at about 1010° C., the cracking mixture entered into the reactor, and the nitrogen acted as the internal standard for the chromatography analysis. The cracking runs lasted for 6 hours, throughout which the conversion of ethane was controlled, trying to keep it at a value of Y_{C2H6}=70%. This was achieved by means of a reactor temperature of about 886° C., and a mean residence time of ˜0.1 s. During the cracking runs, several (up to 12) online injections to the gas chromatographs were made to analyze the effluent of the reactor to control the conversion level, and measure the product distribution. For quantification, the internal standard method (K. M. Van Geem, S. P. P., M. F. Reyniers, J. Vercammen, J. Beens, G. B. Marin, On-line analysis of complex hydrocarbon mixtures using comprehensive two-dimensional gas chromatography. Journal of Chromatography A, 2010. 1217: p. 6623-6633.) was used.

When the 6 hours of cracking were completed, the cracking mixture was sent to the vent (the ethane feed was closed immediately after that), and nitrogen was sent to the reactor. At the same time, the reactor temperature was set to about 900° C., and the flow of ethane was stopped. Once the set temperature was reached, the weight of the sample was registered, to calculate the weight difference between the start and the end of the cracking run, which is the weight of deposited coke (coke gain).

For decoking, the reactor was cooled down to about 750° C. with a steam flow of about 6.7·10⁻⁶ kg/s, and once that temperature was reached, a mix of air (about 8.3·10⁻³ Nl/s) and nitrogen (about 8.3·10⁻³ Nl/s) was fed to the reactor. At the same time that this mix started flowing to the reactor, the temperature of the reactor was set to about 900° C. again, using a heating ramp of about 27° C./hour. As soon as the reactor reached about 900° C., the air flow was maintained, but the nitrogen switched off to also mimic this industrial decoking practice. These conditions were kept for 15 minutes, and then the feed to the reactor was switched back to only N₂ (about 6.7·10⁻³ Nl/s). Finally, and as an “overnight” mode, the reactor was cooled down to about 750° C. with N₂ flowing through, and kept like that until the next cracking run would start. Once the cycles were completed, the reactor was cooled down to the room temperature instead of going to the “overnight” mode.

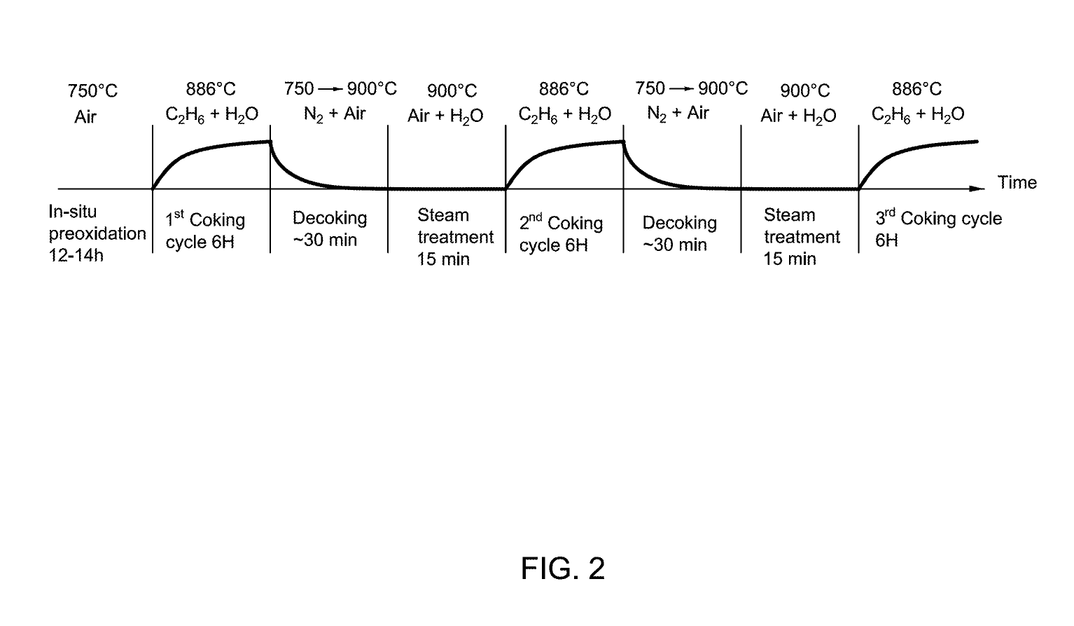

FIG. 2 summarizes the timeline of the experimental procedure, and indicates the main parameters of each stage. The operation parameters and conditions are summarized in Table 3 below. All cooling and heating stages were carried out with a ramp of about 27° C./hour. The heating up to about 900° C. procedure before every cycle is not presented.

TABLE 3
Operation parameters and conditions of the experimental procedure
Cracking (6 hours)

| | |
|---|---|
| Pressure (105 Pa) | about 1.02 |
| Temperature (° C.) | about 886 |
| Ethane flow (Nl · s⁻¹) | about 0.0275 |
| Water with DMDS flow (10⁻⁶ kg · s⁻¹) | about 11.11 |
| N₂ flow (Nl · s⁻¹) | about 0.0067 |

Cooling-down (1 hour)

| | |
|---|---|
| Temperature (° C.) | Cooling up to about 750 |
| Water flow (10⁻⁶ kg · s⁻¹) | about 6.7 |
| N₂ flow (Nl · s⁻¹) | about 0.0067 |

Decoking (30-40 minutes)

| | |
|---|---|
| Temperature (° C.) | Heating up to about 900 |
| Water flow (10⁻⁶ kg · s⁻¹) | about 6.7 |
| N₂ flow (Nl · s⁻¹) | about 0.0083 |
| Air flow (Nl · s⁻¹) | about 0.0083 |

Steam treatment (15 minutes)

| | |
|---|---|
| Temperature (° C.) | about 900 |
| Water flow (10⁻⁶ kg · s⁻¹) | about 6.7 |
| N₂ flow (Nl · s⁻¹) | 0 |
| Air flow (Nl · s⁻¹) | about 0.0083 |

In total, five experiments were performed. Table 4 below illustrates an overview of all the experiments.

TABLE 4

| | | | | Cracking | | |
|---|---|---|---|---|---|---|
| Exper- | | | | duration | | De- |
| iment | Sample | Feed | Cycle | (hours) | Conditions | coking |
| A-B | Uncoated | Ethane | 1st | 6 | T = about | Yes |
| | coupon | Ethane | 2nd | 6 | 886° C.; δ = | Yes |
| | | Ethane | 3rd | 6 | about 0.33 | Yes |
| C | Coupon | Ethane | 1st | 6 | kg water/kg | Yes |
| | coated | Ethane | 2nd | 6 | ethane; | Yes |
| | with | Ethane | 3rd | 6 | about 50 | Yes |
| | slurry 1 | Ethane | 4th | 2 | ppm of | No |
| D | Coupon | Ethane | 1st | 6 | Sulfur per | Yes |
| | coated | Ethane | 2nd | 6 | hydrocarbon | Yes |
| | with | Ethane | 3rd | 6 | with the | Yes |
| | slurry 2 | Ethane | 4th | 2 | addition of | No |
| E | Coupon | Ethane | 1st | 6 | DMDS | Yes |
| | coated | Ethane | 2nd | 6 | | Yes |
| | with | Ethane | 3rd | 6 | | Yes |
| | slurry 3 | Ethane | 4th | 2 | | No |

Table 5 below summarizes all the coking and decoking data for the performed experiments. As can be seen from table 5, for all of the coated coupons, a significant decrease in coke formation during cracking could be observed, compared to the uncoated coupon.

TABLE 5
Coking and decoking data for the performed experiments

| | Coupon | | | | | | | |
|---|---|---|---|---|---|---|---|---|
| | Uncoated | | Coupon coated | | Coupon coated | | Coupon coated | |
| | coupon | | with slurry 1 | | with slurry 2 | | with slurry 3 | |
| | Coke | Coke | Coke | Coke | Coke | Coke | Coke | Coke |
| Cycle | gain | loss | gain | loss | gain | loss | gain | loss |
| 1st | 39 | 35.3 | 5 | 2.8 | 10 | 7 | 10.2 | 9.5 |
| 2nd | 42.5 | 36 | 6.5 | 1.6 | 12 | 8.3 | 11.3 | 8.5 |
| 3rd | | | 9 | 2.9 | 17.2 | 12.5 | 12.6 | 9.3 |
| 4th (2 | | | 6 | no de- | 11.4 | no de- | 8 | no de- |
| hours) | | | | coking | | coking | | coking |

Two gas chromatographs (GCS) were used for the analysis of the effluent stream: an Agilent 6890N Refinery Gas Analyzer (RGA) with a thermal conductivity detector (TCD) and a flame ionization detector (FID), and a Varian 3400 GC equipped with an FID detector.

Table 6 presents the average yields measured during the cracking experiments over the uncoated and coated coupons.

TABLE 6
Average yields over four coking-decoking cycles
with 10-11 analyses per cycle

| | Coupon | | | |
|---|---|---|---|---|
| | | | Coupon | Coupon |
| | Uncoated | Coupon coated | coated | coated |
| | coupon | with slurry 1 | with slurry 2 | with slurry 3 |
| Component | Yield (wt %) | Yield (wt %) | Yield (wt %) | Yield (wt %) |
| H₂ | 5.28 | 5.17 | 4.99 | 5.01 |
| CO₂ | 0.02 | 0.19 | 0.02 | 0.02 |
| CH₄ | 7.06 | 7.12 | 7.08 | 6.90 |
| CO | 0.17 | 0.93 | 0.07 | 0.06 |
| C₂H₆ | 29.66 | 28.57 | 29.80 | 30.13 |
| C₂H₄ | 51.13 | 50.64 | 50.67 | 50.53 |
| C₃H₈ | 0.11 | 0.11 | 0.12 | 0.11 |
| C₃H₆ | 0.75 | 0.78 | 0.81 | 0.80 |
| C₂H₂ | 1.28 | 1.41 | 1.41 | 1.46 |
| 1,3-C₄H₆ | 0.58 | 1.13 | 1.03 | 1.03 |
| Benzene | 2.42 | 2.37 | 2.34 | 2.33 |

As can be seen from table 6, the coupon coated with slurry 1 exhibited 10 times more CO and CO₂ than the other coupons (coated and uncoated ones). No difference in the CO₂ production could be seen for the coupon coated with slurry 2 and the coupon coated with slurry 3 if compared with the uncoated coupon, but the amount of the CO decreased two times.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for cracking hydrocarbon, comprising:
providing hydrocarbon; and
feeding the hydrocarbon into an apparatus having an inner surface accessible to the hydrocarbon, the inner surface comprising a perovskite material and a tuning material; wherein
a yield of coke in the apparatus is lower than that in an apparatus without the perovskite material; and
a yield of carbon monoxide in the apparatus is lower than that in an apparatus without the tuning material.

2. The method of claim 1, wherein the tuning material comprises zirconium oxide, doped zirconium oxide, or any precursor or combination thereof.

3. The method of claim 1, wherein the perovskite material is of formula AₐB_{b}O_{3-δ}, wherein
0.9<a≦1.2;
0.9<b≦1.2;
−0.5<δ<0.5;
A comprises a first element and optionally a second element, the first element is selected from calcium (Ca), strontium (Sr), barium (Ba), lithium (Li), sodium (Na), potassium (K), rubidium (Rb) and any combination thereof, the second element is selected from yttrium (Y), bismuth (Bi), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu) and any combination thereof; and
B is selected from silver (Ag), gold (Au), cadmium (Cd), cerium (Ce), cobalt (Co), chromium (Cr), copper (Cu), dysprosium (Dy), erbium (Er), europium (Eu), ferrum (Fe), gallium (Ga), gadolinium (Gd), hafnium (Hf), holmium (Ho), indium (In), iridium (Ir), lanthanum (La), lutetium (Lu), manganese (Mn), molybdenum (Mo), niobium (Nb), neodymium (Nd), nickel (Ni), osmium (Os), palladium (Pd), promethium (Pm), praseodymium (Pr), platinum (Pt), rhenium (Re), rhodium (Rh), ruthenium (Ru), antimony (Sb), scandium (Sc), samarium (Sm), tin (Sn), tantalum (Ta), terbium (Tb), technetium (Tc), titanium (Ti), thulium (Tm), vanadium (V), tungsten (W), yttrium (Y), ytterbium (Yb), zinc (Zn), zirconium (Zr), and any combination thereof.

4. The method of claim 1, wherein the perovskite material comprises SrCeO₃, SrZr_{0.3}Ce_{0.7}O₃, BaMnO₃, BaCeO₃, BaZr_{0.3}Ce_{0.7}O₃, BaZr_{0.3}Ce_{0.5}Y_{0.2}O₃, BaZr_{0.1}Ce_{0.7}Y_{0.2}O₃, BaZrO₃, BaZr_{0.7}Ce_{0.3}O₃, BaCe_{0.5}Zr_{0.5}O₃, BaCe_{0.9}Y_{0.1}O₃, BaCe_{0.85}Y_{0.15}O₃, BaCe_{0.8} Y_{0.2}O₃, La_{0.1}Ba_{0.9}Ce_{0.7}Zr_{0.2}Y_{0.1}O₃, Ce_{0.1}Ba_{0.9}Ce_{0.7}Zr_{0.2}Y_{0.1}O_{3.05}, Ce_{0.5}Ba_{0.5}Ce_{0.7}Zr_{0.2}Y_{0.1}O_{3.45}, Y_{0.1}Ba_{0.9} Ce_{0.7}Zr_{0.2}Y_{0.1}O₃, Y_{0.5}Ba_{0.5}Ce_{0.7}Zr_{0.2}Y_{0.1}O_{3.2}, Bi_{0.1}Ba_{0.9}Ce_{0.7}Zr_{0.2}Y_{0.1}O₃, Bi_{0.5}Ba_{0.5}Ce_{0.7}Zr_{0.2}Y_{0.1}O_{3.2}, Pr_{0.1}Ba_{0.9}Ce_{0.7}Zr_{0.2}Y_{0.1}O₃, Pr_{0.5}Ba_{0.5}Ce_{0.7}Zr_{0.2}Y_{0.1}O_{3.2}, or any combination thereof.

5. The method of claim 1, wherein a weight of the perovskite material is equal to or less than that of the tuning material.

6. The method of claim 1, wherein a weight ratio of the perovskite material to the tuning material is in a range of from about 7:3 to about 7:93.

7. The method of claim 1, wherein the inner surface comprises a reaction product of the perovskite material and the tuning material.

8. The method of claim 1, wherein the inner surface comprises yttrium oxide.

9. An apparatus for cracking hydrocarbon having an inner surface accessible to the hydrocarbon, the inner surface comprising a perovskite material and a tuning material, wherein
a yield of coke in the apparatus is lower than that in an apparatus without the perovskite material; and
a yield of carbon monoxide in the apparatus is lower than that in an apparatus without the tuning material.

10. The apparatus of claim 9, wherein the tuning material comprises zirconium oxide, doped zirconium oxide, or any precursor or combination thereof.

11. The apparatus of claim 9, wherein the perovskite material is of formula AₐB_{b}O_{3-δ}, wherein
0.9<a≦1.2;
0.9<b≦1.2;
−0.5<δ<0.5;
A comprises a first element and optionally a second element, the first element is selected from calcium (Ca), strontium (Sr), barium (Ba), lithium (Li), sodium (Na), potassium (K), rubidium (Rb) and any combination thereof, the second element is selected from yttrium (Y), bismuth (Bi), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu) and any combination thereof; and
B is selected from silver (Ag), gold (Au), cadmium (Cd), cerium (Ce), cobalt (Co), chromium (Cr), copper (Cu), dysprosium (Dy), erbium (Er), europium (Eu), ferrum (Fe), gallium (Ga), gadolinium (Gd), hafnium (Hf), holmium (Ho), indium (In), iridium (Ir), lanthanum (La), lutetium (Lu), manganese (Mn), molybdenum (Mo), niobium (Nb), neodymium (Nd), nickel (Ni), osmium (Os), palladium (Pd), promethium (Pm), praseodymium (Pr), platinum (Pt), rhenium (Re), rhodium (Rh), ruthenium (Ru), antimony (Sb), scandium (Sc), samarium (Sm), tin (Sn), tantalum (Ta), terbium (Tb), technetium (Tc), titanium (Ti), thulium (Tm), vanadium (V), tungsten (W), yttrium (Y), ytterbium (Yb), zinc (Zn), zirconium (Zr), and any combination thereof.

12. The apparatus of claim 9, wherein the perovskite material comprises SrCeO₃, SrZr_{0.3}Ce_{0.7}O₃, BaMnO₃, BaCeO₃, BaZr_{0.3}Ce_{0.7}O₃, BaZr_{0.3}Ce_{0.5}Y_{0.2}O₃, BaZr_{0.1}Ce_{0.7}Y_{0.2}O₃, BaZrO₃, BaZr_{0.7}Ce_{0.3}O₃, BaCe_{0.5}Zr_{0.5}O₃, BaCe_{0.9}Y_{0.1}O₃, BaCe_{0.85}Y_{0.15}O₃, BaCe_{0.8} Y_{0.2}O₃, La_{0.1}Ba_{0.9}Ce_{0.7}Zr_{0.2}Y_{0.1}O₃, Ce_{0.1}Ba_{0.9}Ce_{0.7}Zr_{0.2}Y_{0.1}O_{3.05}, Ce_{0.5}Ba_{0.5}Ce_{0.7}Zr_{0.2}Y_{0.1}O_{3.45}, Y_{0.1}Ba_{0.9} Ce_{0.7}Zr_{0.2}Y_{0.1}O₃, Y_{0.5}Ba_{0.5}Ce_{0.7}Zr_{0.2}Y_{0.1}O_{3.2}, Bi_{0.1}Ba_{0.9}Ce_{0.7}Zr_{0.2}Y_{0.1}O₃, Bi_{0.5}Ba_{0.5}Ce_{0.7}Zr_{0.2}Y_{0.1}O_{3.2}, Pr_{0.1}Ba_{0.9}Ce_{0.7}Zr_{0.2}Y_{0.1}O₃, Pr_{0.5}Ba_{0.5}Ce_{0.7}Zr_{0.2}Y_{0.1}O_{3.2}, or any combination thereof.

13. The apparatus of claim 9, wherein the perovskite material comprises BaZr_{0.3}Ce_{0.7}O₃.

14. The apparatus of claim 9, wherein the inner surface comprises a reaction product of the perovskite material and the tuning material.

15. The apparatus of claim 9, wherein the inner surface comprises yttrium oxide.

16. The apparatus of claim 9, wherein a weight ratio of the perovskite material to the tuning material is from about 7:3 to about 7:93.

17. The apparatus of claim 9, wherein a weight of the perovskite material is equal to or less than that of the tuning material.

18. The apparatus of claim 9, comprising a tube comprising the inner surface.

19. The apparatus of claim 9, wherein the inner surface comprises a coating of the perovskite material and the tuning material.

20. The apparatus of claim 9, wherein the hydrocarbon comprises ethane, propane, butane, naphtha, bottoms from atmospheric and vacuum distillation of crude oil, or any combination thereof.
